(19) United States
(12) Patent Application Publication
(10) Pub. No.: US 2025/0209807 A1
(43) Pub. Date: Jun. 26, 2025

(54) DYNAMIC NEURAL NETWORK SCHEDULING FOR VISUAL TASKS

(71) Applicant: INTEL CORPORATION, Santa Clara, CA (US)

(72) Inventors: Rodrigo Aldana Lopez, Zapopan (MX); David Gomez Gutierrez, Zapopan (MX); Leobardo E. Campos-Macías, Guadalajara (MX)

(73) Assignee: INTEL CORPORATION, Santa Clara, CA (US)

(21) Appl. No.: 19/060,350

(22) Filed: Feb. 21, 2025

(51) Int. Cl. G06V 10/96; G06V 10/25; G06V 10/70; G06V 10/776; G06V 10/82

(52) U.S. Cl. CPC G06V 10/96; G06V 10/25; G06V 10/776; G06V 10/82; G06V 10/87

(57) ABSTRACT

An example apparatus includes interface circuitry, machine-readable instructions, and at least one processor circuit to be programmed by the machine-readable instructions to identify at least one region of interest associated with a computer vision task, measure accuracy of the computer vision task in a covariance space, the accuracy of the computer vision task associated with computer resource consumption, and select at least one neural network from a group of neural networks based on the measured accuracy of the computer vision task.

### BACKGROUND

Computer vision allows for the extraction of information from images and videos. Computer vision-associated tasks are applicable to facial recognition, self-driving vehicles, robotic automation, and sports performance analysis. Object-related information is captured using one or more cameras, allowing computer vision-based pattern recognition algorithms to process images to identify objects.

### BRIEF DESCRIPTION OF THE DRAWINGS

FIG. 1 is a block diagram of an example implementation of neural network identifier circuitry constructed in accordance with teachings of this disclosure to perform dynamic neural network scheduling.

FIG. 2 is a flowchart representative of example machine-readable instructions and/or example operations that may be executed, instantiated, and/or performed by example programmable circuitry to implement the example neural network identifier circuitry of FIG. 1.

FIG. 3 is a flowchart representative of example machine-readable instructions and/or example operations that may be executed, instantiated, and/or performed by example programmable circuitry to implement the example neural network identifier circuitry of FIG. 1 to select a neural network sequence for subsequent tracking.

FIG. 4 illustrates example target tracking using region-based convolutional neural networks (R-CNNs) in combination with the example neural network identifier circuitry of FIG. 1.

FIG. 5 illustrates an example average precision of different region-based convolutional neural networks based on neural network architecture and feature extraction.

FIG. 6A illustrates an example covariance evolution based on previous covariance states and/or perception decisions.

FIG. 6B illustrates an example covariance space based on perception decisions.

FIG. 7 illustrates example random tree construction based on new nodes associated with least cost connections.

FIG. 8 illustrates an example experimental assessment of three perception configurations using neural network scheduling methods and apparatus disclosed herein.

FIG. 9 is a block diagram of an example processing platform including programmable circuitry structured to execute, instantiate, and/or perform the example machine readable instructions and/or perform the example operations of FIGS. 2-3 to implement the neural network identifier circuitry of FIG. 1.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 2-3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Computer vision tasks can be performed based on information extracted from image data and/or video data. Such tasks can include object tracking, motion estimation, scene reconstruction, virtual reality, facial recognition, three-dimensional pose estimation and/or other applications. As such, high-level information can be captured to generate and/or execute task-related decisions (e.g., prediction, estimation, detection, localization, etc.). However, technical challenges associated with computer vision tasks include optimizations of tracking accuracy, latency, and/or computational resource utilization, which are particularly relevant for surveillance, security, and/or crowd management applications. Known methods rely on a static vision arrangement (e.g., a predetermined neural network architecture) that can result in excessive resource consumption and/or inadequate tracking performance. For instance, high-accuracy networks deliver superior tracking precision at the cost of significant computational resources, whereas networks with lower accuracy are more resource-efficient but compromise on tracking quality.

Known methods use a single, fixed neural network architecture for object tracking and other computer vision-related tasks. Such fixed neural network architectures can be broadly categorized into high-precision networks and low-precision networks. High-precision networks include large, compute-intensive neural networks that provide high tracking accuracy at the cost of significant computational resources. These network architectures are often impractical for real-time applications on resource-constrained devices. An alternative approach is employing small, less resource-intensive neural networks that offer lower tracking accuracy but are more suitable for real-time applications on limited hardware. However, such network architectures may fail to provide a desired level of precision for reliable tracking. In both cases, there is a lack of flexibility to dynamically adapt to different performance and/or resource needs, leading to excessive resource consumption and/or insufficient tracking accuracy.

Methods and apparatus disclosed herein allow for efficient and accurate computer vision-based task performance using dynamic neural network scheduling. In examples disclosed herein, dynamic scheduling can be used to select the most suitable neural network from a pool of neural networks with different accuracy, latency, and/or computational demands. The selection process is contingent on immediate tracking requirements and available computational resources, aiming to harmonize tracking precision with computational efficiency across a dynamic time frame. Methods and apparatus disclosed herein maintain target tracking accuracy in the presence of environmental changes (e.g., different lighting conditions, crowded scenes, etc.) that can impair the performance of vision systems. Moreover, methods and apparatus disclosed herein perform fine-tuning of central processing unit (CPU) usage by avoiding overly cautious fixed configurations of known target tracking techniques, thereby ensuring the judicious use of computational resources without sacrificing tracking outcomes. As such, methods and apparatus disclosed herein enhance visual based tasks such as object tracking (e.g., autonomous driving, etc.), but are not constrained to these tasks, allowing for applications in obstacle detection, navigation, and/or simultaneous localization and mapping (SLAM). By dynamically adapting to changing conditions and resource availability, methods and apparatus disclosed herein ensure the reliable and efficient operation of autonomous systems in diverse and dynamic environments.

For example, visual tasks that are part of a control loop (e.g., tasks associated with robotics, unmanned aerial vehicles (UAVs), etc.) can experience a high latency of visual algorithm(s) or a sensing delay (e.g., even if the algorithm is accurate) that can lead to instability associated with agile tasks. Methods and apparatus disclosed herein allow for improved selection of appropriate visual algorithm(s) to meet a prescribed performance, selecting among accuracy, latency and/or a computational budget while improving the performance of a closed loop system. Methods and apparatus disclosed herein provide significant value by enhancing the efficiency and accuracy of real-time object tracking in robotics and/or autonomous driving-based applications (e.g. involving object tracking with deployment on resource-constrained devices). For example, methods and apparatus disclosed herein ensure accurate tracking performance, benefiting a wide range of applications from surveillance to autonomous navigation. Achieving a balance between performance and efficiency results in cutting-edge, practical artificial intelligence (AI)-based implementations on the edge (e.g., facilitating the processing of delay-sensitive applications near a data source), allowing for overall improvements in neural network performance through network/model selection and/or scheduling.

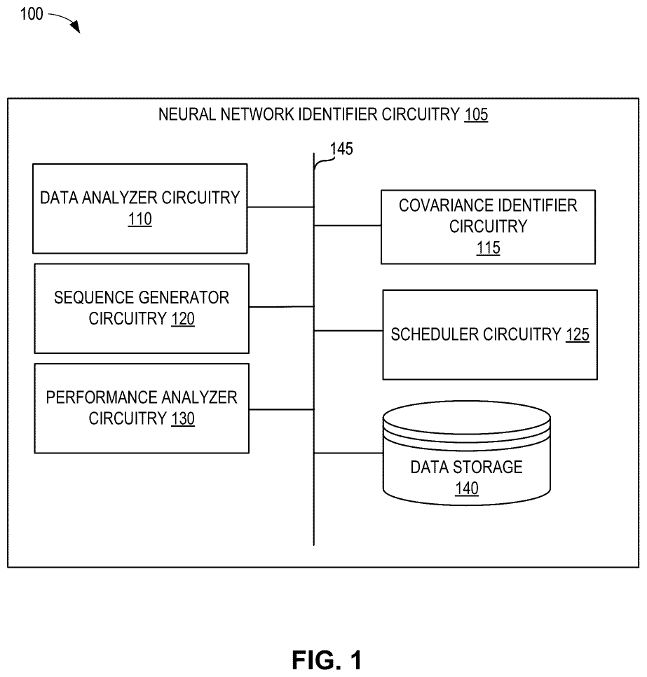

FIG. 1 is a block diagram 100 illustrating an example implementation of neural network identifier circuitry 105 constructed in accordance with teachings of this disclosure to perform dynamic neural network scheduling. The neural network identifier circuitry 105 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the neural network identifier circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the neural network identifier circuitry 105 includes example data analyzer circuitry 110, example covariance identifier circuitry 115, example sequence generator circuitry 120, example scheduler circuitry 125, example performance analyzer circuitry 130, and example data storage 140. In the example of FIG. 1, the data analyzer circuitry 110, the covariance identifier circuitry 115, the sequence generator circuitry 120, the scheduler circuitry 125, the performance analyzer circuitry 130, and the data storage 140 are in communication via an example bus 145.

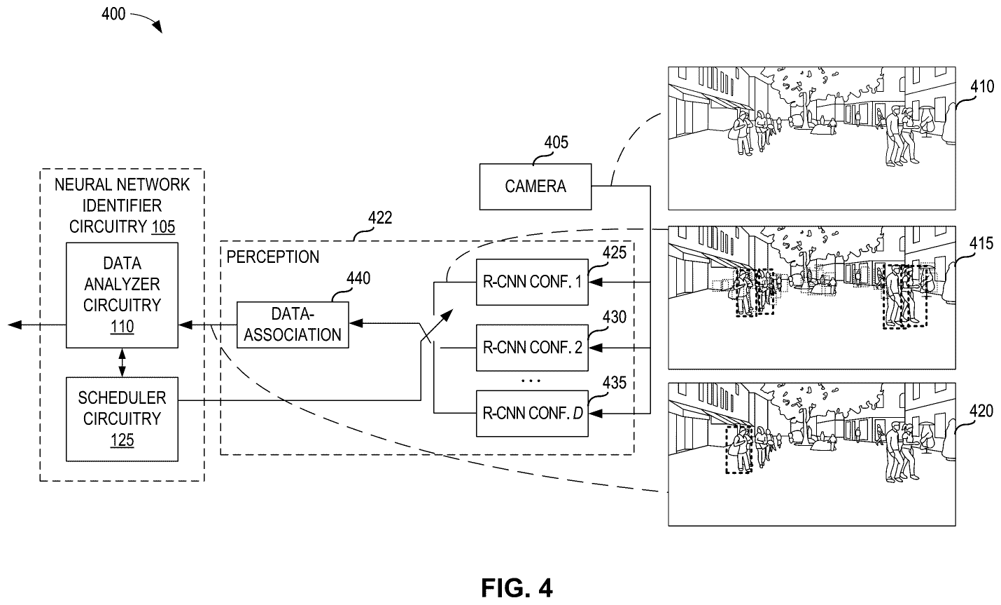

The data analyzer circuitry 110 identifies one or more regions of interest based on tracking input data. For example, the data analyzer circuitry 110 identifies at least one region of interest associated with a computer vision task (e.g., the computer vision task tracking at least one object in a plurality of regions). In some examples, the data analyzer circuitry 110 output(s) data associations based on analysis performed in connection with the computer vision task, as described in more detail in connection with FIG. 4. For example, during a data association phase of an object tracking task, one or more detected objects are linked across multiple video frames based on object detection results obtained using one or more perception options (e.g., algorithms, neural networks such as a region-based convolutional neural network (R-CNN), etc.). In examples disclosed herein, the neural network identifier circuitry 105 identifies which one or more perception option(s) to implement for the computer vision task at a given time (e.g., to improve tracking accuracy and resource usage). For example, at an instant k, the data analyzer circuitry 110 identifies a subsequent window of T video frames as part of identifying a future sequence (e.g., pₖ, . . . p_{k+T}) of neural networks by minimizing a cost function (Jₖ) (e.g., as shown in connection with Equation 1), where the term Σₗ₌₁^{T} tr(\hat{P}[k+l]) represents a mean squared error associated with an updated covariance matrix (\hat{P}[k+l]), Cₖ represents an expected resource usage for the sequence pₖ, . . . p_{k+T}, and λ₁, λ₂>0 represent weighting parameters to balance between tracking accuracy and resource usage:

$${J}_{k} = {λ}_{1} {\sum }_{l = 1}^{T} tr ( \hat{P} [ k + l ] ) + {λ}_{2} {C}_{k} \qquad Equation 1$$

For example, once the data analyzer circuitry 110 identifies a neural network sequence (pₖ, . . . p_{k+T}) minimizing Jₖ, the neural network identifier circuitry 105 applies the first neural network (pₖ) in the sequence and the data analyzer circuitry 110 proceeds to repeat the identification of the neural network sequence for a subsequent time step.

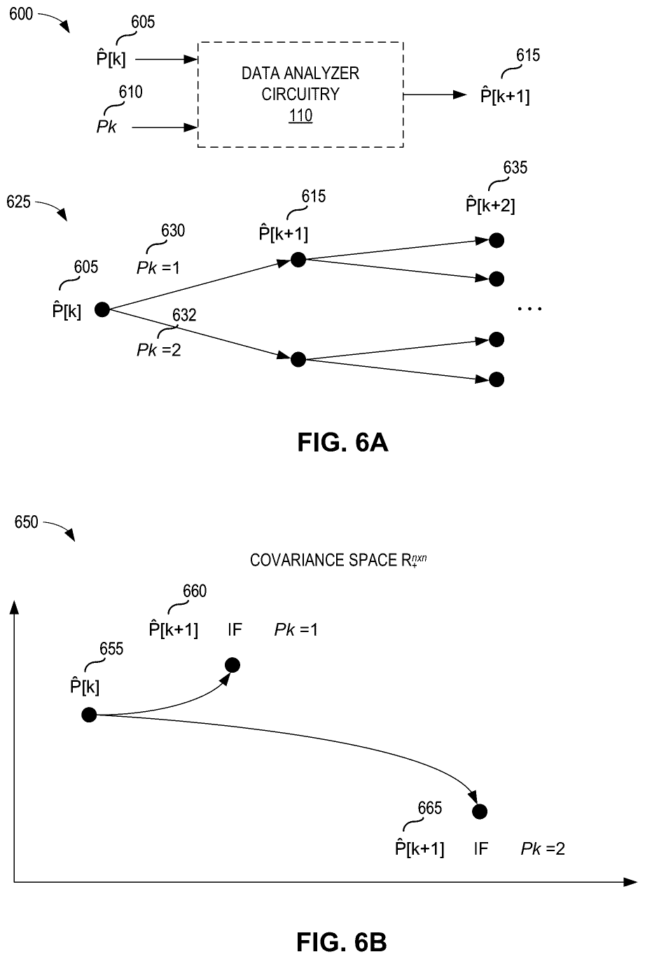

In general, the data analyzer circuitry 110 can use an estimator (e.g., such as a Kalman filter) to produce a state estimate given existing measurements and a covariance matrix (e.g., \hat{P}[k]) that measures accuracy for the state estimation. For example, usual estimator structures are given by a recursive structure where the updated covariance (\hat{P}[k+1]) depends on a previous covariance (\hat{P}[k]), as well as a covariance associated with the selected perception option (Rₚ_{ₖ}), as described in more detail in connection with FIG. 6A (e.g., illustrating the dependence of a covariance evolution on a previous covariance state and existing perception decisions). As such, identifying a neural network sequence (pₖ, . . . p_{k+T}) that reduces the cost function (Jₖ) can require investigating a multitude of possible combinations of perception sequences to determine the sequence with the least cost. However, such an approach is not feasible for large windows of T video frames. Instead, methods and apparatus disclosed herein investigate the covariance space, as described in more detail in connection with FIG. 6B (e.g., illustrating the covariance space and possible covariance evolutions according to perception decisions) and the covariance identifier circuitry 115.

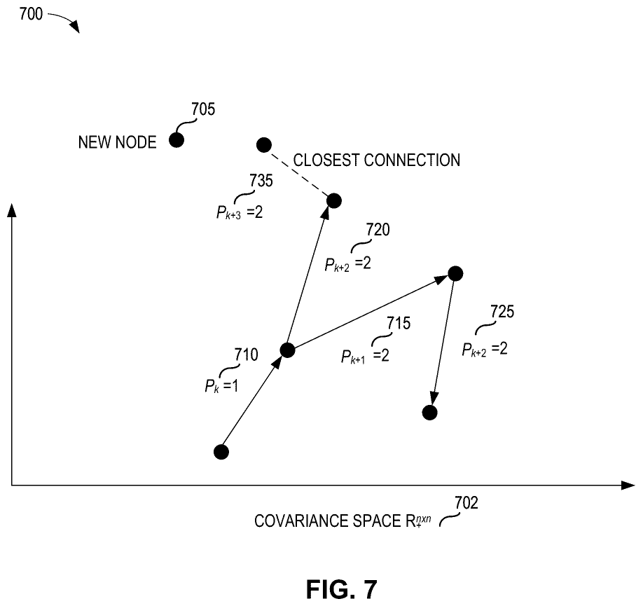

The covariance identifier circuitry 115 identifies an accuracy of a neural network selection and/or updates the covariance to reduce a cost function. Given a state as defined by \hat{P}[k], perception decisions (e.g., neural network selections) can serve as actions to move to different points in the covariance space. Motivated by motion planning techniques, the covariance identifier circuitry 115 relies on sampling-based methodologies to traverse the covariance space to find near-optimal covariance trajectories. For example, the covariance identifier circuitry 115 initializes a tree with an initial node \hat{P}[k] and samples a new point in the covariance space. For each node in the tree that is less than T nodes from the initial node, the covariance identifier circuitry 115 identifies all perception decisions and searches for the option closer to a newly sampled node, adding the newly sampled node to the list of potential new nodes. For each node in the list of potential new nodes, the covariance identifier circuitry 115 searches for the node with the least cost measured towards the initial node and adds the new node to the tree of nodes. As such, the covariance identifier circuitry 115 tracks the sequence of decisions in the tree that result in the least cost (e.g., by minimizing the cost function (Jₖ)). For example, as shown in connection with FIG. 7 (e.g., illustrating random tree construction through the connection of new nodes according to least cost connections), random decisions can be continuously explored, allowing for a sequence of perception options (e.g., a neural network sequence) to be obtained within a given period of time.

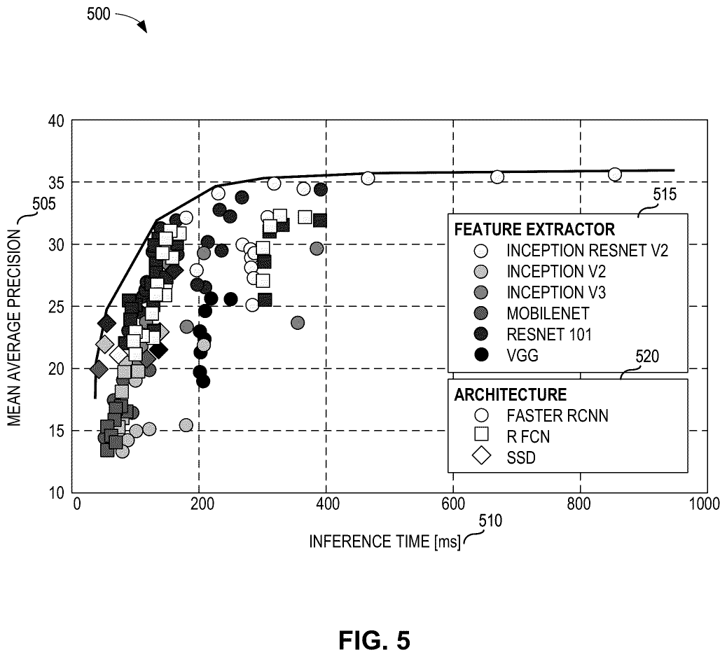

The sequence generator circuitry 120 generates a sequence of perception options (e.g., algorithms, neural network(s), etc.) to apply to a subsequent tracking estimate. For example, the sequence generator circuitry 120 generates the sequence of neural networks (pₖ, . . . p_{k+T}) that reduces the cost function (Jₖ), as determined using the covariance identifier circuitry 115. In some examples, the sequence generator circuitry 120 generates the sequence based on a bank of perception options used to determine which perception method improves tracking accuracy and resource usage. In some examples, at time k, the sequence generator circuitry 120 selects between D possible perception options (e.g., pₖ∈{1, . . . , D}), such that each perception option (pₖ) has an accuracy given by a covariance matrix (Rₚ_{ₖ}), as illustrated in connection with FIG. 5. For example, a bank of D neural networks can be used to perform a computer vision task involving the object of feature tracking (e.g., such as surveillance, localization, etc.), where each neural network has a different architecture, size, and/or performance.

The scheduler circuitry 125 schedules a different neural network at each point of a computer vision task (e.g., object tracking) according to visual tracking performance and resource usage needs. For example, as shown in connection with FIG. 4, the computer vision task includes a perception stage followed by a data association phase, the results of which the data analyzer circuitry 110 uses to identify a region of interest corresponding to a target of interest. The data analyzer circuitry 110 and the covariance identifier circuitry 115 subsequently implement an estimation algorithm (e.g., such as a Kalman filter or a particle filter) to estimate the state of the target given all available data, allowing the sequence generator circuitry 120 to identify a sequence of neural networks to use in a subsequent time frame of the computer vision task. As such, the scheduler circuitry 125 schedules the neural network(s) based on a sequence identified using the sequence generator circuitry 120. For example, the scheduler circuitry 125 schedules the sequence of neural networks based on a current accuracy state of the computer vision task.

The scheduler circuitry 125 allows for the dynamic scheduling of neural networks for use in a computer vision system, such that the neural network(s) are selected from a predefined set, each with distinct accuracy, latency, and/or resource requirements. In some examples, the scheduler circuitry 125 performs the neural network selection based on a real-time analysis of tracking performance and resource availability (e.g., using the performance analyzer circuitry 130), allowing for improved tracking accuracy and resource usage during video frame processing. In examples disclosed herein, the scheduler circuitry 125 allows for adaptive neural network switching for real-time tracking. For example, switching between neural networks with different accuracy and resource demands is performed based on real-time tracking needs (e.g., using the data analyzer circuitry 110 to update the object's state), maintaining accuracy within predefined limits while reducing computational resource use. As described in more detail above, methods and apparatus disclosed herein reduce computational complexity in neural network scheduling through sampling within a covariance space representing estimator accuracy, identifying improved neural network selections through a heuristic-based tree exploration to reduce a cost function, and selecting near-optimal sequences for network application.

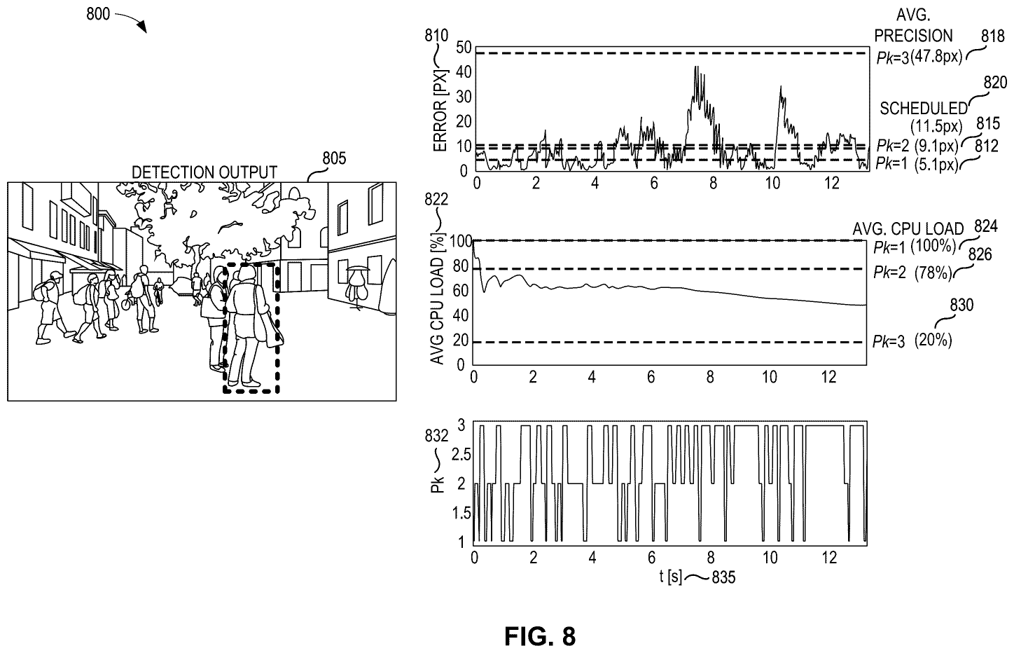

The performance analyzer circuitry 130 performs real-time analysis of tracking performance and computational resource availability. For example, when the performance analyzer circuitry 130 identifies excessive resource consumption or insufficient tracking accuracy, the scheduler circuitry 125 proceeds to select a neural network sequence for subsequent tracking to improve accuracy and resource usage, based on the identification of a near-optimal covariance trajectory using a selection of available neural network(s). For example, as described in connection with FIG. 8, available neural networks can include (1) a precise neural network requiring a high CPU load (100%), (2) a reasonably precise neural network with a lower CPU load (78%), and (3) an imprecise neural network with a low CPU load (20%). Based on performance and resource availability results identified using the performance analyzer circuitry 130, the scheduler circuitry 125 schedules among the different configurations in time, allowing for both tracking accuracy and reduced loads on the CPU.

The data storage 140 can be used to store any information associated with the data analyzer circuitry 110, the covariance identifier circuitry 115, the sequence generator circuitry 120, the scheduler circuitry 125, and/or the performance analyzer circuitry 130. The data storage 140 of the illustrated example of FIG. 1 can be implemented by any memory, storage device and/or storage disc for storing data such as flash memory, magnetic media, optical media, etc. Furthermore, the data stored in the data storage 140 can be in any data format such as binary data, comma delimited data, tab delimited data, structured query language (SQL) structures, image data, etc.

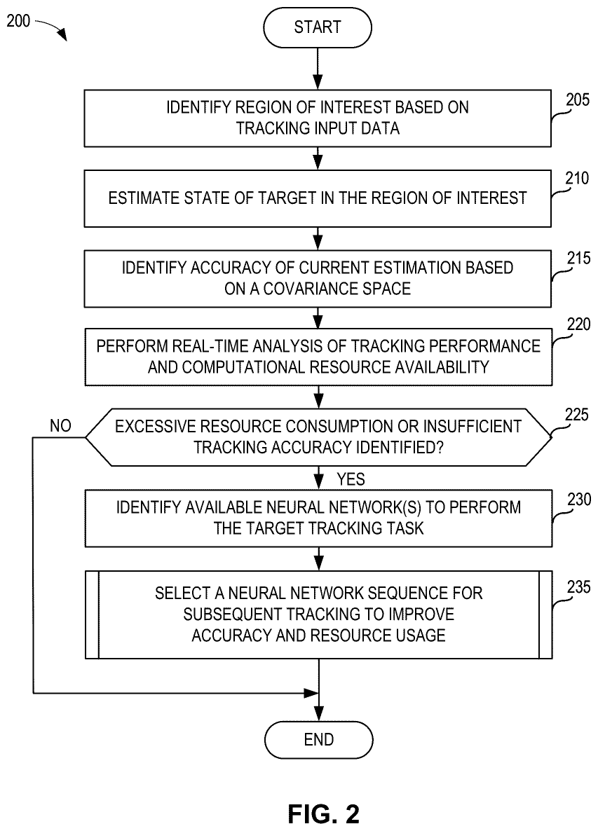

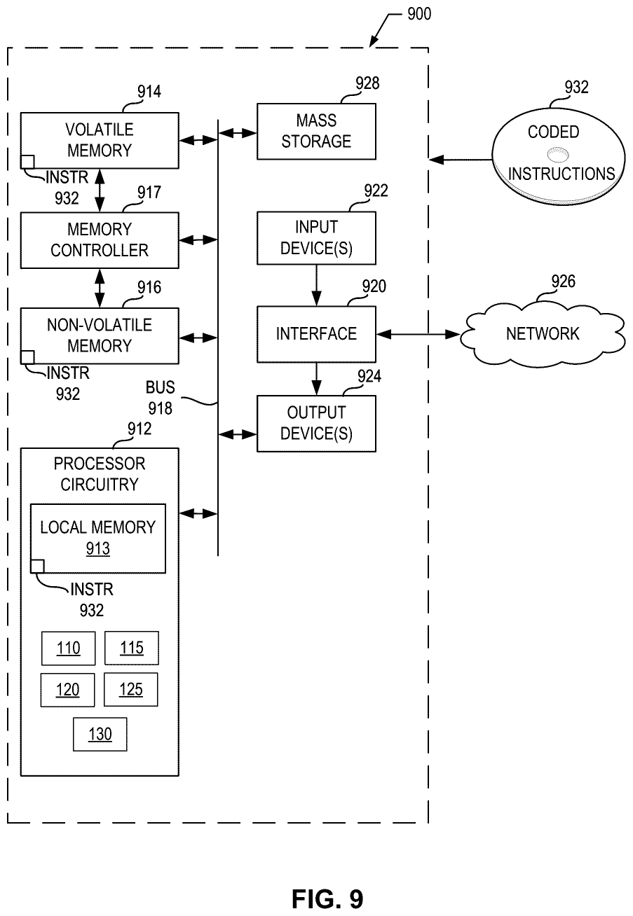

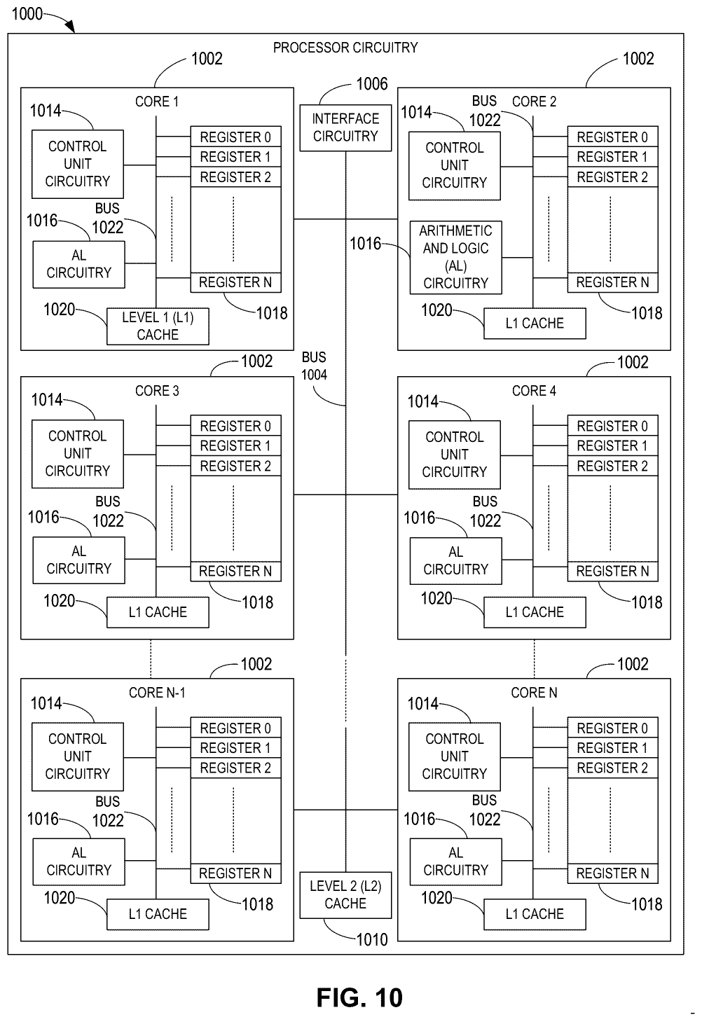

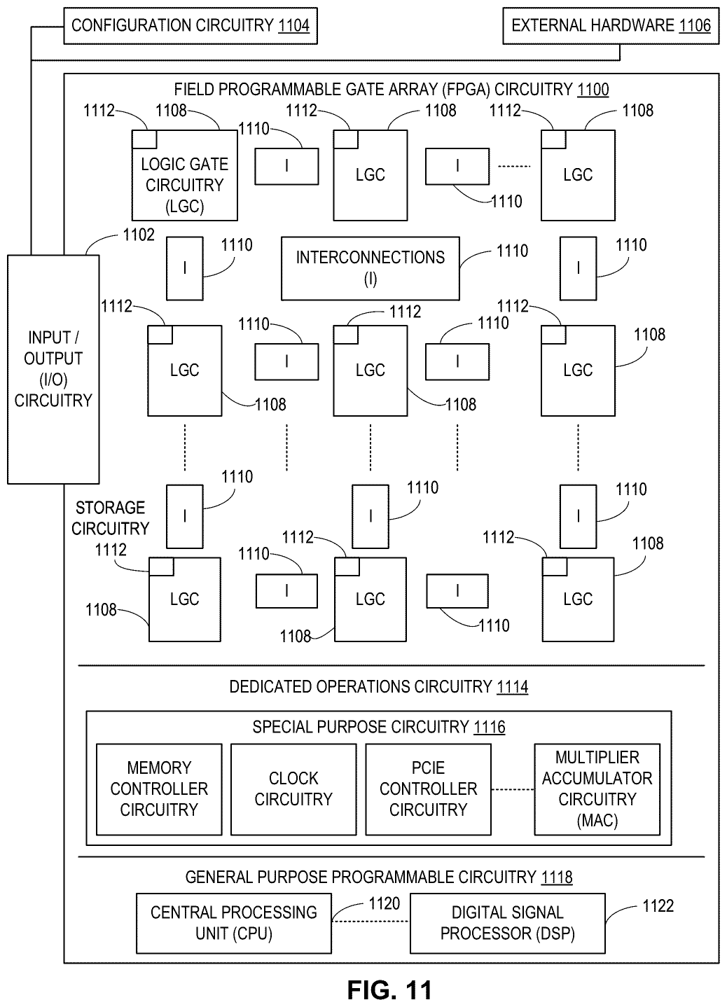

In some examples, the apparatus includes means for identifying a region of interest. For example, the means for identifying a region of interest may be implemented by data analyzer circuitry 110. In some examples, the data analyzer circuitry 110 may be instantiated by programmable circuitry such as the example programmable circuitry 912 of FIG. 9. For instance, the data analyzer circuitry 110 may be instantiated by the example microprocessor 1000 of FIG. 10 executing machine executable instructions such as those implemented by at least block 205 of FIG. 2. In some examples, the data analyzer circuitry 110 may be instantiated by hardware logic circuitry, which may be implemented by an ASIC, XPU, or the FPGA circuitry 1100 of FIG. 11 structured to perform operations corresponding to the machine readable instructions. Additionally or alternatively, the data analyzer circuitry 110 may be instantiated by any other combination of hardware, software, and/or firmware. For example, the data analyzer circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

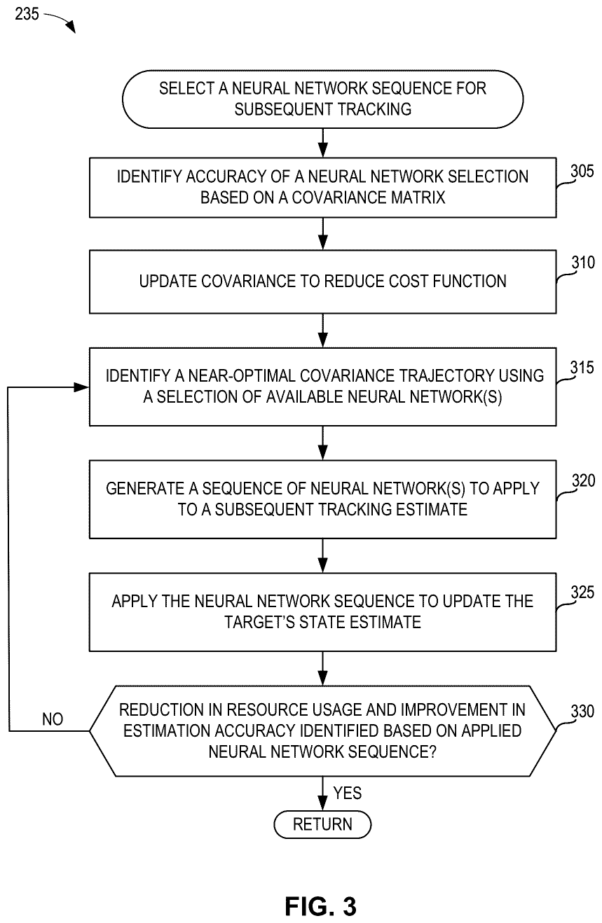

In some examples, the apparatus includes means for identifying a covariance. For example, the means for identifying a covariance may be implemented by covariance identifier circuitry 115. In some examples, the covariance identifier circuitry 115 may be instantiated by programmable circuitry such as the example programmable circuitry 912 of FIG. 9. For instance, the covariance identifier circuitry 115 may be instantiated by the example microprocessor 1000 of FIG. 10 executing machine executable instructions such as those implemented by at least block 310 of FIG. 3. In some examples, the covariance identifier circuitry 115 may be instantiated by hardware logic circuitry, which may be implemented by an ASIC, XPU, or the FPGA circuitry 1100 of FIG. 11 structured to perform operations corresponding to the machine readable instructions. Additionally or alternatively, the covariance identifier circuitry 115 may be instantiated by any other combination of hardware, software, and/or firmware. For example, the covariance identifier circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a sequence of neural networks. For example, the means for generating a sequence of neural networks may be implemented by sequence generator circuitry 120. In some examples, the sequence generator circuitry 120 may be instantiated by programmable circuitry such as the example programmable circuitry 912 of FIG. 9. For instance, the sequence generator circuitry 120 may be instantiated by the example microprocessor 1000 of FIG. 10 executing machine executable instructions such as those implemented by at least block 320 of FIG. 3. In some examples, the sequence generator circuitry 120 may be instantiated by hardware logic circuitry, which may be implemented by an ASIC, XPU, or the FPGA circuitry 1100 of FIG. 11 structured to perform operations corresponding to the machine readable instructions. Additionally or alternatively, the sequence generator circuitry 120 may be instantiated by any other combination of hardware, software, and/or firmware. For example, the sequence generator circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for applying the neural networks. For example, the means for applying the neural networks may be implemented by scheduler circuitry 125. In some examples, the scheduler circuitry 125 may be instantiated by programmable circuitry such as the example programmable circuitry 912 of FIG. 9. For instance, the scheduler circuitry 125 may be instantiated by the example microprocessor 1000 of FIG. 10 executing machine executable instructions such as those implemented by at least block 325 of FIG. 3. In some examples, the scheduler circuitry 125 may be instantiated by hardware logic circuitry, which may be implemented by an ASIC, XPU, or the FPGA circuitry 1100 of FIG. 11 structured to perform operations corresponding to the machine readable instructions. Additionally or alternatively, the scheduler circuitry 125 may be instantiated by any other combination of hardware, software, and/or firmware. For example, the scheduler circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying the accuracy of a computer vision task. For example, the means for identifying the accuracy of a computer vision task may be implemented by performance analyzer circuitry 130. In some examples, the performance analyzer circuitry 130 may be instantiated by programmable circuitry such as the example programmable circuitry 912 of FIG. 9. For instance, the performance analyzer circuitry 130 may be instantiated by the example microprocessor 1000 of FIG. 10 executing machine executable instructions such as those implemented by at least block 330 of FIG. 3. In some examples, the performance analyzer circuitry 130 may be instantiated by hardware logic circuitry, which may be implemented by an ASIC, XPU, or the FPGA circuitry 1100 of FIG. 11 structured to perform operations corresponding to the machine readable instructions. Additionally or alternatively, the performance analyzer circuitry 130 may be instantiated by any other combination of hardware, software, and/or firmware. For example, the performance analyzer circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the neural network identifier circuitry 105 is illustrated in FIG. 1, one or more of the elements, processes and/or devices illustrated in FIG. 1 may be combined, divided, re-arranged, omitted, eliminated and/or implemented in any other way. Further, the example data analyzer circuitry 110, the example covariance identifier circuitry 115, the example sequence generator circuitry 120, the example scheduler circuitry 125, the example performance analyzer circuitry 130, and/or, more generally, the neural network identifier circuitry 105 of FIG. 1 may be implemented by hardware, software, firmware and/or any combination of hardware, software and/or firmware. Thus, for example, any of the example data analyzer circuitry 110, the example covariance identifier circuitry 115, the example sequence generator circuitry 120, the example scheduler circuitry 125, the example performance analyzer circuitry 130, and/or, more generally, the neural network identifier circuitry 105 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the neural network identifier circuitry 105 of FIG. 1 may include one or more elements, processes, and/or devices in addition to, or instead of, those illustrated in FIG. 1, and/or may include more than one of any or all of the illustrated elements, processes and devices.

Flowcharts representative of example machine readable instructions, which may be executed by programmable circuitry to implement and/or instantiate the neural network identifier circuitry 105 of FIG. 1 and/or representative of example operations which may be performed by programmable circuitry to implement and/or instantiate the neural network identifier circuitry 105, are shown in FIGS. 2-3. The machine readable instructions may be one or more executable programs or portion(s) of one or more executable programs for execution by programmable circuitry, such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2-3, many other methods of implementing the example neural network identifier circuitry 105 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine-readable instructions and/or example operations 200 that may be executed, instantiated, and/or performed by example programmable circuitry to implement the example neural network identifier circuitry of FIG. 1. The machine-readable instructions and/or the operations 200 of FIG. 2 begin at block 205, at which the data analyzer circuitry 110 identifies a region of interest based on tracking input data. For example, the data analyzer circuitry 110 receives input from a data association phase of an object tracking task, such that detected objects are linked across multiple video frames based on object detection results obtained using one or more neural networks (e.g., region-based convolutional neural network (R-CNN), etc.). In some examples, the data analyzer circuitry 110 estimates a state of the target in the region of interest, at block 210. Subsequently, the covariance identifier circuitry 115 identifies an accuracy of the current estimation based on a covariance space (e.g., a current accuracy state in the form of a covariance matrix), at block 215.

For example, as described in more detail in connection with FIG. 3, the covariance space can be used to identify one or more neural networks for reducing computational resource use while maintaining a desired level of tracking accuracy. In some examples, the performance analyzer circuitry 130 performs real-time analysis of tracking performance and computational resource availability, at block 220. For example, the performance analyzer circuitry 130 determines whether the one or more neural network(s) used for an object tracking task meets the desired level(s) of resource consumption and tracking accuracy. For example, as shown in connection with FIG. 8, a particular object tracking task can include the use of a precise neural network requiring a high CPU load, a reasonably precise neural network with a slightly lower CPU load, or an imprecise neural network with a low CPU load. If the performance analyzer circuitry 130 determines that the one or more neural network(s) currently in use result in excessive resource consumption or insufficient tracking accuracy, at block 225, the sequence generator circuitry 120 identifies available neural network(s) to perform the target tracking task, at block 230. For example, the sequence generator circuitry 120 identifies a bank of available D neural networks that can be used to perform a computer vision task involving the object of feature tracking (e.g., surveillance, localization, etc.), such that each neural network has a different architecture, size, and/or performance. The sequence generator circuitry 120 proceeds to select a neural network sequence for subsequent tracking to improve accuracy and resource usage, at block 235, as described in more detail in connection with FIG. 3.

FIG. 3 is a flowchart representative of example machine-readable instructions and/or example operations 235 that may be executed, instantiated, and/or performed by example programmable circuitry to implement the example neural network identifier circuitry of FIG. 1 to select a neural network sequence for subsequent tracking. The machine-readable instructions and/or the operations 300 of FIG. 3 begin at block 305, at which the covariance identifier circuitry 115 identifies the accuracy of a neural network selection based on a covariance matrix. For example, as described in connection with FIG. 1, neural network selections can serve as actions to move to different points in the covariance space. The covariance identifier circuitry 115 tracks the sequence of decisions that result in the least cost (e.g., by reducing the cost function (k)), at block 310. For example, the covariance identifier circuitry 115 traverses the covariance space to find near-optimal covariance trajectories, at block 315, and searches for the option closer to a newly sampled node, adding the newly sampled node to the list of potential new nodes.

The sequence generator circuitry 120 generates a sequence of perception options (e.g., algorithms, neural network(s), etc.) to apply to a subsequent tracking estimate, at block 320. For example, the sequence generator circuitry 120 generates the sequence of neural networks (pₖ, . . . p_{k+T}) that reduces the cost function (Jₖ), as determined using the covariance identifier circuitry 115. The scheduler circuitry 125 proceeds to apply the neural network sequence to update the target's state estimate, at block 325. For example, the scheduler circuitry 125 schedules a different neural network at each point of the computer vision task according to visual tracking performance and resource usage needs. In some examples, the scheduler circuitry 125 performs the neural network selection based on a real-time analysis of tracking performance and resource availability tracking. In the example of FIG. 3, the performance analyzer circuitry 130 determines whether there is a reduction in resource usage and/or an improvement in estimation accuracy based on the applied neural network sequence, at block 330. For example, if the performance analyzer circuitry 130 determines that the neural network sequence does not result in a reduction in resource usage and an improvement in estimation accuracy, control returns to the covariance identifier circuitry 115, at block 315, to update the near-optimal covariance trajectory using a bank of available neural networks.

FIG. 4 illustrates an example target tracking 400 using region-based convolutional neural networks (R-CNNs) in combination with the example neural network identifier circuitry 105 of FIG. 1. In the example of FIG. 4, camera 405 captures information associated with real-time object tracking (e.g., single object tracking, multiple object tracking). In some examples, an object of interest is captured using an image sequence or a sequence of video frames (e.g., first image 410). Regions of interest in the video frame(s) can be segmented to identify objects of interest (e.g., persons identified in a second image 415), with subsequent identification of a single object of interest (e.g., a single individual identified in a third image 420) as part of a perception phase 422 of the computer vision task. In the example of FIG. 4, a bank of neural networks (e.g., R-CNN configurations 425, 430, 435) can be used for precise localization of objects within images through the generation of bounding boxes (e.g., as shown in connection with the second image 415).

During an example data association phase 440, a region of interest corresponding to the target of interest is selected (e.g., as shown in connection with the third image 420). Data from the data association phase 440 is provided to the neural network identifier circuitry 105. For example, the data analyzer circuitry 110 proceeds to apply an estimation algorithm (e.g., such as a Kalman filter or a particle filter) to estimate the state of the target identified during the data association phase 440. Subsequently, the scheduler circuitry 125 applies a sequence of identified neural networks for subsequent object tracking frames based on identification of a near-optimal covariance trajectory, as described in connection with FIGS. 2-3. As such, the neural network identifier circuitry 105 schedules a different neural network at each point of object tracking according to visual tracking performance and resource usage needs, as identified using the performance analyzer circuitry 130 of FIG. 1. As such, methods and apparatus disclosed herein ensure efficient and accurate object tracking in real-time applications.

Furthermore, methods and apparatus disclosed herein improve person tracking by using covariance matrices of estimator accuracy to guide the selection of neural networks from a predefined set. For example, performance optimization using covariance metrics balances tracking accuracy and resource use over time, while combinatorial reduction via covariance-based space exploration reduces computational complexity in neural network scheduling by sampling within a covariance space, identifying optimal neural network choices through heuristic-based tree exploration to reduce a cost function, and selecting near-optimal sequences for network-based applications. Additionally, adaptive neural network switching disclosed herein for real-time tracking involves switching among neural networks with different accuracy and resource demands based on real-time tracking needs, maintaining accuracy within predefined limits while reducing resource use.

In some examples, the target tracking 400 of FIG. 4 can be applied to autonomous systems (e.g., integrations with a mission planner to provide real-time tracking commands, combining fast tracking algorithms with low-frequency identification methods to maintain accurate identification over time). In some examples, methods and apparatus disclosed herein can be used for real-time three-dimensional scene reconstruction (e.g., using software platforms such as Intel® SceneScape) in combination with existing edge infrastructure management platforms (e.g., Intel® Tiber™ Edge Platform, etc.). For example, object tracking methods and apparatus disclosed herein can be implemented for person-based tracking using unmanned aerial vehicle (UAV) motion planning associated with high-level mission commands by combining a computer vision tracking algorithm (e.g., such as DeepSORT) for fast person tracking and scheduling the tracking algorithm using aligned re-identification (e.g., AlignedReID, a low-frequency person identification technique).

FIG. 5 illustrates example average precision 500 of different region-based convolutional neural networks based on neural network architecture and feature extraction. For example, each neural network provides a measurement with some nominal precision (e.g., mean average precision 505) over a set period of time (e.g., inference time period 510), as shown in FIG. 5. The average precision differs over time based on the selection of a feature extractor (e.g., feature extractor(s) 515 including Residual Networks (ResNet), Visual Geometry Group (VGG) networks, etc.) and/or the corresponding architecture (e.g., network architecture(s) 520 such as region-based fully convolutional networks (R-FCNs), Single Shot MultiBox Detector (SSD) network, etc.). For example, at time k, a total of D possible perception options (e.g., neural networks, algorithms, etc.) can be selected (e.g., as represented by pₖ∈{1, . . . , D}, where pₖ is a given neural network obtained from a total of D potential neural networks). In examples disclosed herein, each perception option includes a given accuracy represented by a covariance matrix (Rₚ_{ₖ}) that can be used for updating a covariance during identification of a perception sequence.

FIG. 6A illustrates an example covariance evolution 600 based on previous covariance states and/or perception decisions. In the example of FIG. 6A, the data analyzer circuitry 110 of FIG. 1 uses an estimator (e.g., such as a Kalman filter) to produce a state estimate given (1) measurements received from the data association phase 440 of FIGS. 4 and (2) an example first covariance matrix (\hat{P}[k]) 605 associated with a particular neural network (pₖ) 610 that measures accuracy for the state estimation. For example, usual estimator structures are given by a recursive structure where a second covariance matrix (\hat{P}[k+1]) 615 depends on the first covariance matrix (\hat{P}[k]) 605 as well as the covariance of the selected perception option (Rₚ_{ₖ}) obtained in connection with FIG. 5. In the example of FIG. 6A, a node diagram 625 shows that the first covariance matrix (\hat{P}[k]) 605 serves as a precursor to the second covariance matrix (\hat{P}[k+1]) 615, while the second covariance matrix 615 serves as a precursor to the third covariance matrix (\hat{P}[k+2]) 635, such that the nodes represented by the matrices are based on the perception options selected for the object detection task (e.g., a first neural network (pₖ=1), a second neural network (pₖ=2), etc.). Separately, FIG. 6B illustrates an example covariance space 650 based on perception decisions. In examples disclosed herein, the covariance space 650 illustrates a state represented by a covariance matrix (\hat{P}[k]) 655, where the perception decisions serve as actions to move to different points in this space. For example, a first subsequent covariance matrix 660 (\hat{P}[k+1]) associated with the first neural network selection (pₖ=1) has a node separate from a second subsequent covariance matrix 665 (\hat{P}[k+1]) associated with the second neural network selection (pₖ=2), as described in more detail in connection with FIG. 7.

FIG. 7 illustrates example random tree construction 700 based on new nodes associated with least cost connections. As described in connection with FIG. 1, the covariance identifier circuitry 115 traverses an example covariance space 702 to find near-optimal covariance trajectories. For each node in a list of potential new nodes (e.g., new node 705), the covariance identifier circuitry 115 searches for the node with the least cost measured towards the initial node and adds the new node to the tree of nodes, tracking the sequence of decisions that result in the least cost, allowing the sequence generator circuitry 120 of FIG. 1 to determine the sequence of neural networks (pₖ, . . . p_{k+T}) that reduce the cost function. In the example of FIG. 7, near-optimal covariance trajectories in the covariance space 702 are identified using the covariance identifier circuitry 115. For example, once the tree is initialized using an initial node (\hat{P}[k]), as shown in connection with FIG. 6A, the covariance identifier circuitry 115 samples a new point in the covariance space 702. Subsequently, the covariance identifier circuitry 115 identifies all perception decisions (e.g., select neural networks) that are closer to the newly sampled node (e.g., for each node in the tree with several steps from the initial node less than T frames), forming a list of potential new nodes, as shown in FIG. 7. For each node in the list of potential new nodes, the covariance identifier circuitry 115 proceeds to identify a node that has a least cost measured towards the initial node (e.g., new node 705), adding the identified node to the existing tree of nodes. The covariance identifier circuitry 115 tracks the sequence of decisions in the tree of nodes showing the least cost, allowing the sequence generator circuitry 120 to select the neural network sequence based on a reduction of the cost function. In the example of FIG. 7, the neural network sequence (pₖ, . . . p_{k+T}) is identified based on the generated nodes using network selections 710, 715, 720, 725, 735. For example, the nodes change depending on the neural network selections for each T frame (e.g., selecting a first neural network (e.g., pₖ=1) for network selection 710 and a second neural network (pₖ₊₁=2, pₖ₊₂=2, pₖ₊₃=2) for network selection(s) 715, 720, 725, 735, etc.). In the example of FIG. 7, the closest connection to the new node 705 is formed at the node generated when selecting pₖ₊₃=2 for frame T=3 in the sequence of neural networks.

FIG. 8 illustrates an example experimental assessment 800 of three perception configurations using neural network scheduling methods and apparatus disclosed herein. In the example of FIG. 8, a detection output 805 includes a bounding box identifying a target of interest within a specific region of interest. The three perception configurations used to identify the detection output 805 can be assessed based on an example error 810. In the example of FIG. 8, the three perception configurations include (1) a precise neural network requiring a high CPU load (e.g., CPU load of 100%), as represented by identifier 812 for pₖ=1, (2) a reasonably precise neural network with a middle CPU load (e.g., CPU load of 78%), as represented by identifier 815 for pₖ=2, and (3) an imprecise neural network with a low CPU load (e.g., CPU load of 20%), as represented by identifier 818 for pₖ=3. Additionally, the results include error measurements associated with a scheduled neural network sequence 820 that includes the combined use of the various neural network selections (pₖ=1, pₖ=2, pₖ=3) during a given computer vision task. In the example of FIG. 8, the error is lower for the more precise neural network (pₖ=1) with the highest CPU load and increases significantly for the less precise neural network (pₖ=3) with the lowest CPU load, whereas scheduling between different configurations in time yields reasonable results in tracking accuracy, near the nominal accuracy of the first two neural networks (pₖ=1 and pₖ=2). In the example of FIG. 8, an average CPU load 822 is shown for the three neural networks, with the more precise neural network (pₖ=1) having the highest CPU load (e.g., a first load 824), the reasonably precise neural network (pₖ=2) having a relatively high CPU load (e.g., a second load 826), and the imprecise neural network having the lowest CPU load (e.g., a third load 830). However, when the neural networks are scheduled to be performed in a given sequence, the CPU load varies depending on the neural network in use. As such, the proposed scheduling of a neural network sequence alleviates the burden on the CPU seen in connection with the first two neural networks, achieving a substantially lower CPU load. For example, switching between the possible configurations achieves a CPU load of approximately 50%. FIG. 7 further illustrates alterations in neural network selection over time, where an example neural network selection 832 (pₖ) varies among the three neural networks tested based on an identified neural network sequence as described in connection with FIGS. 1-3.

FIG. 9 is a block diagram of an example programmable circuitry platform 900 structured to execute and/or instantiate the example machine-readable instructions and/or the example operations of FIGS. 2-3 to implement the example neural network identified circuitry 105 of FIG. 1. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs microprocessors, CPUs, GPUs, DSPs, and/or microcontrollers from any desired family or manufacturer. The programmable circuitry 912 may be implemented by one or more semiconductor based (e.g., silicon based) devices. In this example, the processor circuitry 912 implements the data analyzer circuitry 110, the covariance identifier circuitry 115, the sequence generator circuitry 120, the scheduler circuitry 125, and the performance analyzer circuitry 130.

The programmable circuitry 912 of the illustrated example includes a local memory 913 (e.g., a cache, registers, etc.). The programmable circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 900 of the illustrated example also includes one or more mass storage devices 928 to store software and/or data. Examples of such mass storage devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 932, which may be implemented by the machine readable instructions of FIGS. 2-3, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 2-3 to effectively instantiate the circuitry of FIG. 1 logic circuits to perform the operations corresponding to those machine readable instructions. In some such examples, the circuitry of FIG. 1 is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 2-3.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 2-3 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2-3. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2-3. As such, the FPGA circuitry 1100 may be configured and/or structured to effectively instantiate some or all of the operations/functions corresponding to the machine readable instructions of the flowcharts of FIGS. 2-3 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 2-3 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 2-3 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 11. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1102 of FIG. 11 may execute a first portion of the machine readable instructions represented by the flowchart(s) of FIGS. 2-3 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 2-3, and/or an ASIC may be configured and/or structured to perform third operation(s)/function(s) corresponding to a third portion of the machine readable instructions represented by the flowcharts of FIGS. 2-3.

It should be understood that some or all of the circuitry of FIG. 1 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 1 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9 which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

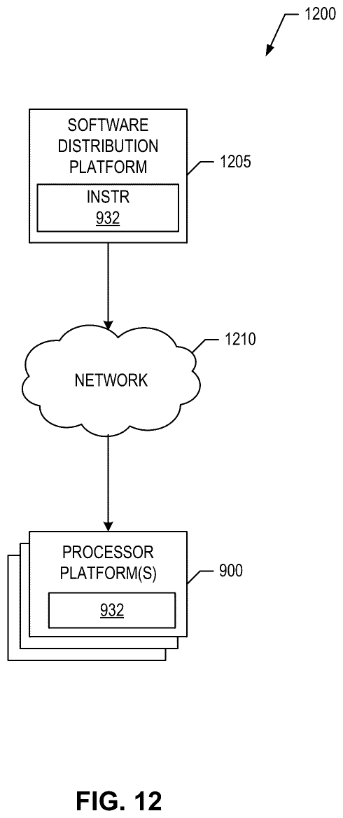

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 2-3, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 2-3, may be downloaded to the example programmable circuitry platform 900, which is to execute the machine readable instructions 932 to implement the neural network identifier circuitry 105 of FIG. 1. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein permit efficient and accurate computer vision-based task performance using dynamic neural network scheduling. Methods and apparatus disclosed herein introduce dynamic neural network scheduling to select the most suitable neural network from a pool of models with different accuracy, latency, and/or computational demands. For example, target tracking accuracy is maintained in the presence of environmental changes that can otherwise impair the performance of computer vision systems. As such, methods and apparatus disclosed herein enhance tasks associated with object tracking (e.g., autonomous driving, etc.) and/or any other computer vision task applications (e.g., obstacle detection, navigation, and/or simultaneous localization and mapping (SLAM)). Thus, examples disclosed herein result in improvements to the operation of a machine.

Example methods, apparatus, systems, and articles of manufacture for efficient and accurate visual tasks using dynamic neural network scheduling are disclosed herein. Further examples and combinations thereof include the following:

Example 1 includes an apparatus, comprising interface circuitry, machine-readable instructions, and at least one processor circuit to be programmed by the machine-readable instructions to identify at least one region of interest associated with a computer vision task, measure accuracy of the computer vision task in a covariance space, the accuracy of the computer vision task associated with computer resource consumption, and select at least one neural network from a group of neural networks based on the measured accuracy of the computer vision task.

Example 2 includes the apparatus of example 1, wherein one or more of the at least one processor circuit is to identify a near-optimal covariance trajectory based on the group of neural networks available to perform the computer vision task.

Example 3 includes the apparatus of example 1 and/or example 2, wherein one or more of the at least one processor circuit is to generate a sequence of neural networks to perform the computer vision task based on a reduction of a cost function.

Example 4 includes the apparatus of any one or more of examples 1-3, wherein the reduction of the cost function is based on at least one of (1) a mean squared error associated with a covariance matrix or (2) a weighting parameter associated with a tracking accuracy or a resource usage.

Example 5 includes the apparatus of any one or more of examples 1-4, wherein the computer vision task is a target tracking task, one or more of the at least one processor circuit is to identify the accuracy of the computer vision task based on an estimation algorithm.

Example 6 includes the apparatus of any one or more of examples 1-5, wherein the estimation algorithm is at least one of a Kalman filter or a particle filter.

Example 7 includes the apparatus of any one or more of examples 1-6, wherein one or more of the at least one processor circuit is to maintain target tracking accuracy during an environmental change.

Example 8 includes at least one non-transitory machine-readable medium comprising machine-readable instructions to cause at least one processor circuit to at least identify at least one region of interest associated with a computer vision task, measure accuracy of the computer vision task in a covariance space, the accuracy of the computer vision task associated with computer resource consumption, and select at least one neural network from a group of neural networks based on the measured accuracy of the computer vision task.

Example 9 includes the at least one non-transitory machine-readable medium of example 8, wherein the instructions are to cause one or more of the at least one processor circuit to identify a near-optimal covariance trajectory based on the group of neural networks available to perform the computer vision task.

Example 10 includes the at least one non-transitory machine-readable medium of example 8 and/or example 9, wherein the machine-readable instructions are to cause one or more of the at least one processor circuit to generate a sequence of neural networks to perform the computer vision task based on a reduction of a cost function.

Example 11 includes the at least one non-transitory machine-readable medium of one or more of examples 8-10, wherein the reduction of the cost function is based on at least one of (1) a mean squared error associated with a covariance matrix or (2) a weighting parameter associated with a tracking accuracy or a resource usage.

Example 12 includes the at least one non-transitory machine-readable medium of one or more of examples 8-11, wherein the machine-readable instructions are to cause one or more of the at least one processor circuit to identify the accuracy of the computer vision task based on an estimation algorithm.

Example 13 includes the at least one non-transitory machine-readable medium of one or more of examples 8-12, wherein the estimation algorithm is at least one of a Kalman filter or a particle filter.

Example 14 includes the at least one non-transitory machine-readable medium of one or more of examples 8-13, wherein the machine-readable instructions are to cause one or more of the at least one processor circuit to maintain target tracking accuracy during an environmental change.

Example 15 includes an apparatus, comprising means for identifying at least one region of interest associated with a computer vision task, means for measuring accuracy of the computer vision task in a covariance space, the accuracy of the computer vision task being associated with computer resource consumption, and means for selecting at least one neural network from a group of neural networks based on the measured accuracy of the computer vision task.

Example 16 includes the apparatus of example 15, wherein the means for measuring accuracy is to identify a near-optimal covariance trajectory based on the group of neural networks available to perform the computer vision task.

Example 17 includes the apparatus of example 15 and/or example 16, wherein the means for selecting is to generate a sequence of neural networks based on a reduction of a cost function.

Example 18 includes the apparatus of one or more of examples 15-17, wherein the reduction of the cost function is based on at least one of (1) a mean squared error associated with a covariance matrix or (2) a weighting parameter associated with a tracking accuracy or a resource usage.

Example 19 includes the apparatus of one or more of examples 15-18, wherein the means for measuring accuracy is to identify the accuracy of the computer vision task based on an estimation algorithm.

Example 20 includes the apparatus of one or more of examples 15-19, wherein the estimation algorithm is at least one of a Kalman filter or a particle filter.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
identify at least one region of interest associated with a computer vision task;
measure accuracy of the computer vision task in a covariance space, the accuracy of the computer vision task associated with computer resource consumption; and
select at least one neural network from a group of neural networks based on the measured accuracy of the computer vision task.

2. The apparatus of claim 1, wherein one or more of the at least one processor circuit is to identify a near-optimal covariance trajectory based on the group of neural networks available to perform the computer vision task.

3. The apparatus of claim 1, wherein one or more of the at least one processor circuit is to generate a sequence of neural networks to perform the computer vision task based on a reduction of a cost function.

4. The apparatus of claim 3, wherein the reduction of the cost function is based on at least one of (1) a mean squared error associated with a covariance matrix or (2) a weighting parameter associated with a tracking accuracy or a resource usage.

5. The apparatus of claim 1, wherein the computer vision task is a target tracking task, one or more of the at least one processor circuit is to identify the accuracy of the computer vision task based on an estimation algorithm.

6. The apparatus of claim 5, wherein the estimation algorithm is at least one of a Kalman filter or a particle filter.

7. The apparatus of claim 1, wherein one or more of the at least one processor circuit is to maintain target tracking accuracy during an environmental change.

8. At least one non-transitory machine-readable medium comprising machine-readable instructions to cause at least one processor circuit to at least:
identify at least one region of interest associated with a computer vision task;
measure accuracy of the computer vision task in a covariance space, the accuracy of the computer vision task associated with computer resource consumption; and
select at least one neural network from a group of neural networks based on the measured accuracy of the computer vision task.

9. The at least one non-transitory machine-readable medium of claim 8, wherein the instructions are to cause one or more of the at least one processor circuit to identify a near-optimal covariance trajectory based on the group of neural networks available to perform the computer vision task.

10. The at least one non-transitory machine-readable medium of claim 8, wherein the machine-readable instructions are to cause one or more of the at least one processor circuit to generate a sequence of neural networks to perform the computer vision task based on a reduction of a cost function.

11. The at least one non-transitory machine-readable medium of claim 10, wherein the reduction of the cost function is based on at least one of (1) a mean squared error associated with a covariance matrix or (2) a weighting parameter associated with a tracking accuracy or a resource usage.

12. The at least one non-transitory machine-readable medium of claim 8, wherein the machine-readable instructions are to cause one or more of the at least one processor circuit to identify the accuracy of the computer vision task based on an estimation algorithm.

13. The at least one non-transitory machine-readable medium of claim 12, wherein the estimation algorithm is at least one of a Kalman filter or a particle filter.

14. The at least one non-transitory machine-readable medium of claim 8, wherein the machine-readable instructions are to cause one or more of the at least one processor circuit to maintain target tracking accuracy during an environmental change.

15. An apparatus, comprising:
means for identifying at least one region of interest associated with a computer vision task;
means for measuring accuracy of the computer vision task in a covariance space, the accuracy of the computer vision task being associated with computer resource consumption; and
means for selecting at least one neural network from a group of neural networks based on the measured accuracy of the computer vision task.

16. The apparatus of claim 15, wherein the means for measuring accuracy is to identify a near-optimal covariance trajectory based on the group of neural networks available to perform the computer vision task.

17. The apparatus of claim 15, wherein the means for selecting is to generate a sequence of neural networks based on a reduction of a cost function.

18. The apparatus of claim 17, wherein the reduction of the cost function is based on at least one of (1) a mean squared error associated with a covariance matrix or (2) a weighting parameter associated with a tracking accuracy or a resource usage.

19. The apparatus of claim 15, wherein the means for measuring accuracy is to identify the accuracy of the computer vision task based on an estimation algorithm.

20. The apparatus of claim 19, wherein the estimation algorithm is at least one of a Kalman filter or a particle filter.
